(19) United States
(12) Patent Application Publication
(10) Pub. No.: US 2014/0297368 A1
(43) Pub. Date: Oct. 2, 2014

(54) SYSTEM AND METHOD FOR DETERMINING THE MARKET PRICE FOR AN INDIVIDUAL DIAMOND

(71) Applicant: Mordechai Haim Ferder, Irvine, CA (US)

(72) Inventor: Mordechai Haim Ferder, Irvine, CA (US)

(21) Appl. No.: 13/855,551

(22) Filed: Apr. 2, 2013

(51) Int. Cl. G06Q 30/02

(52) U.S. Cl. CPC G06Q 30/0206
USPC 705/7.35

(57) ABSTRACT

A diamond appraisal system and method is described that allows a user select a diamond to be appraised. Based on characteristics of the appraisal diamond, comparison diamonds are selected from one or more market databases. The comparison diamonds are associated with historical or current actual market prices, which reflect actual sale prices or proposed sale prices for each of the comparison diamonds. Premium and discount weights are applied to these actual market prices to generate an estimated market price for the appraisal diamond. By computing the estimated market price of the appraisal diamond relative to the actual market prices of other diamonds, the diamond appraisal system and method determines the monetary value of the appraisal diamond relative to changing market conditions.

### FIELD

A system and method is described that determines an estimated market price of an individual diamond based on premium and discount weights applied to actual market prices of one or more comparison diamonds. Other embodiments are also described.

### BACKGROUND

Purchasing a diamond is often a confusing and challenging process. Complications with the purchase of a diamond are often caused by the numerous criteria that may be used to calculate the value of a diamond. For example, diamond wholesalers often use ten or more separate characteristics and factors for calculating the value of diamonds. Differences between separate characteristics may alter the price of diamonds in a non-linear fashion. For example, the clarity of a diamond may more significantly affect the price of a diamond than the color of the diamond. Further, separate professional gemologist may deliver greatly varied appraisals for the same diamond as each gemologist may value characteristics of the diamond in a different fashion. Accordingly, determining prices for diamonds is a non-intuitive and difficult process as grades are not lineally correlated with monetary market value.

To alleviate some of the risk and uncertainty in diamond purchasing and appraisals, wholesalers often trade in “baskets” of diamonds. Although trading in multiple diamonds simultaneously alleviates some of the risk in purchasing diamonds, this technique provides no assistance or relief to individuals who seek to purchase a single diamond. However, even when purchased in quantities, each individual diamond must still be evaluated independently.

### SUMMARY

An embodiment of the invention is directed to a diamond appraisal system and method that allows a user select a diamond to be appraised. The selection may be performed by entering characteristics of the appraisal diamond or by entering a certification identifier corresponding to characteristics of the appraisal diamond. Based on characteristics of the appraisal diamond, the diamond appraisal system and method selects a set of comparison diamonds from one or more market databases. The comparison diamonds are associated with historical or current actual market prices, which reflect actual sale prices or proposed sale prices for each of the comparison diamonds. Premium and discount weights are applied to these actual market prices to generate market prices for the appraisal.

By computing the estimated market price of the appraisal diamond relative to the actual market prices of other diamonds, the diamond appraisal system and method determines the monetary value of the appraisal diamond relative to changing market conditions. This estimated market value may thereafter be utilized by a consumer/user to determine a bid price for the appraisal diamond or whether a proposed purchase price for the appraisal diamond is a fair offer in light of market conditions.

In one embodiment, the diamond appraisal system and method selects a set of alternative diamonds, which are identical or are nearly identical to the appraisal diamond. The system and method may estimate the market prices for both the appraisal diamond and the alternative diamonds. By estimating market prices for alternative diamonds in addition to the original appraisal diamond, the consumer/user may determine if there are better values in the market for similar diamonds.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

Embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one.

FIG. 1 shows a diamond appraisal system according to one embodiment of the invention.

FIGS. 2A-2C show a method for appraising/estimating the price of an individual diamond and viewing possible alternative diamonds according to one embodiment of the invention.

FIG. 3 shows estimated market prices for twenty-five appraisal diamonds based on a single comparison diamond according to one embodiment of the invention.

FIG. 4 shows a user interface, which presents the characteristics and estimated market price of the appraisal diamond and the characteristics and estimated market prices of one-hundred alternative diamonds.

### DETAILED DESCRIPTION

Several embodiments are described with reference to the appended drawings are now explained. While numerous details are set forth, it is understood that some embodiments of the invention may be practiced without these details. In other instances, well-known circuits, structures, and techniques have not been shown in detail so as not to obscure the understanding of this description.

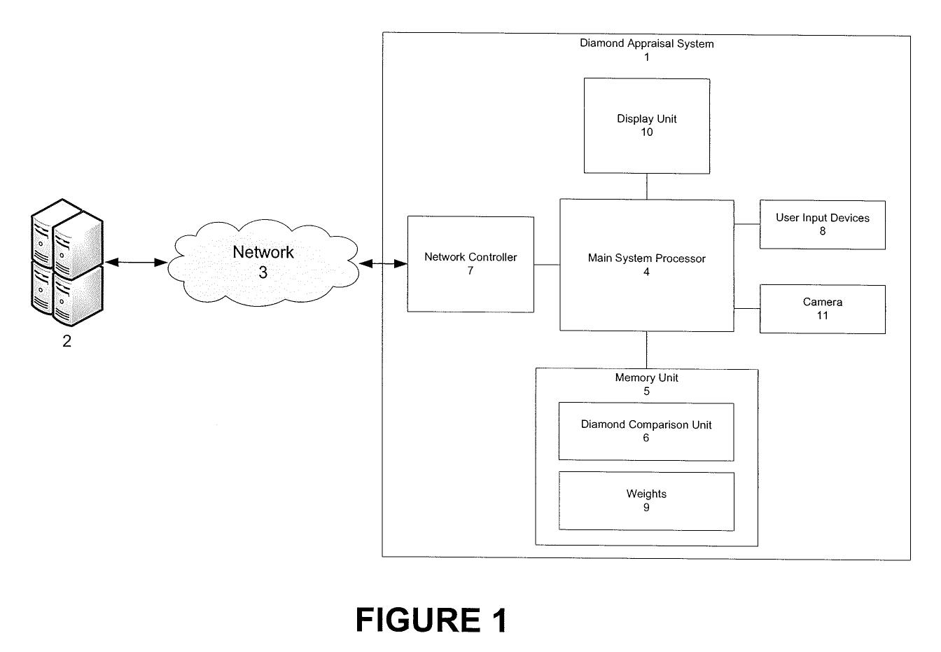

FIG. 1 shows a diamond appraisal system 1 according to one embodiment of the invention. The diamond appraisal system 1 may interoperate with one or more external systems 2 over wired and/or wireless networks 3 as shown. The diamond appraisal system 1 estimates the market value/price of an individual diamond based on historical and/or current market prices for similar diamonds. Each element of the diamond appraisal system 1 will be described by way of example below.

The diamond appraisal system 1 may include a main system processor 4 and a memory unit 5. The processor 4 and memory unit 5 are generically used here to refer to any suitable combination of programmable data processing components and data storage that conduct the operations needed to implement the various functions and operations of the diamond appraisal system 1. The processor 4 may be a special purpose processor such as an application-specific integrated circuit (ASIC), a general purpose microprocessor, a field-programmable gate array (FPGA), a digital signal controller, or a set of hardware logic structures (e.g., filters, arithmetic logic units, and dedicated state machines) while the memory unit 5 may refer to microelectronic, non-volatile random access memory. An operating system may be stored in the memory unit 5, along with application programs specific to the various functions of the diamond appraisal system 1, which are to be run or executed by the processor 4 to perform the various functions of the diamond appraisal system 1. For example, the memory unit 5 may store a diamond comparison unit 6, which in conjunction with other hardware elements of the diamond appraisal system 1, estimates/appraises the monetary value/price of a designated diamond based on historical and current market data. The diamond comparison unit 6 will be described in further detail below.

In one embodiment, the diamond appraisal system 1 may also include a network controller 7 that facilitates communications with remote/external devices. For example, the network controller 7 may assist in transmitting and receiving data (e.g., diamond characteristics corresponding to an input certificate number and/or historical/current diamond market prices) to/from the external systems 2 over the network 3. The network controller 7 may be a wireless network controller (e.g., an IEEE 802.11x, a Global System for Mobile Communications (GSM), a Code division multiple access (CDMA), a Long Term Evolution (LTE), or a BLUETOOTH transceiver) and/or a wired network controller (e.g., an IEEE 802.3x or a Plain Old Telephone Service (POTS) transceiver). The network controller 7 may facilitate communications between the diamond appraisal system 1 and the external systems 2 through an intermediate component (e.g., a router or a hub).

The diamond appraisal system 1 may include one or more user input devices 8 for receiving input from one or more users/customers. For example, the input devices 8 may include a keyboard, a pointing device (e.g., a mouse or touchpad), a touch sensitive monitor, or any similar device. The one or more user input devices 8 may be communicatively coupled to other components of the diamond appraisal system 1 through a combination of wired and wireless mediums and buses. In one embodiment, the user input devices 8 allow a user to enter a certificate number and/or characteristics corresponding to an individual diamond to be analyzed and appraised.

In one embodiment, the memory unit 5 stores weights 9 (e.g., premiums and discounts) that may be used to estimate the value of an appraisal diamond in terms of the market value/prices for other diamonds currently or previously available in the market. The weights 9 may be stored in any type of data structure or database. In one embodiment, these weights 9 may be periodically updated by an administrator or other user through the network controller 7 or the user input devices 8. The application of these weights 9 to determine the market price for an appraisal diamond will be described in further detail below.

The diamond appraisal system 1 may include a display unit 10 for presenting a diamond analysis to a user. The diamond analysis, as will be discussed in further detail below, describes an estimated monetary value/price of a diamond in relation to similar current diamonds for sale or similar previously sold diamonds. The display unit 9 may use any display technology including a liquid crystal display (LCD), an organic light-emitting diode (OLED) display, a cathode ray tube (CRT) display, or plasma display panel (PDP).

As described above, the diamond appraisal system 1 may communicate with the external systems 2 over the network 3. The external systems 2 may be computers and servers operated by one or more gemological organizations and/or one or more diamond markets. For example, the external systems 2 may be operated by the Gemological Institute of America (GIA), the International Gemological Institute (IGI), the European Gemological Laboratory (EGL), the American Gemological Society (AGS), the Hoge Raad voor de Diamant (HRD Antwerp), the Canadian Institute of Gemmology (CIG), and/or the Gemmological Association of Great Britain. As will be described in further detail below, the external systems 2 may communicate grading/certification data for one or more diamonds as well as historical and current market prices for multiple diamonds based on specified characteristics.

In one embodiment, the diamond appraisal system 1 may include a camera 11 for capturing still images and/or video. The camera 11 may include any type of sensor for selectively capturing two-dimensional or three-dimensional images and/or video, including a charge-coupled device (CCD) or a complementary metal-oxide-semiconductor (CMOS). The camera 11 may include any set of digital or optical filters for de-noising, enhancing, or otherwise improving the images and/or video for processing.

In some embodiment, the diamond appraisal system 1 is a portable phone, a tablet computer, a laptop computer, a desktop computer, a mainframe computer, a server, or any similar computing platform. Although shown in a single indivisible unit, in other embodiments the diamond appraisal system 1 may be comprised of multiple distributed computing units working in parallel to estimate the market price of an individual diamond based on actual market prices of one or more comparison diamonds.

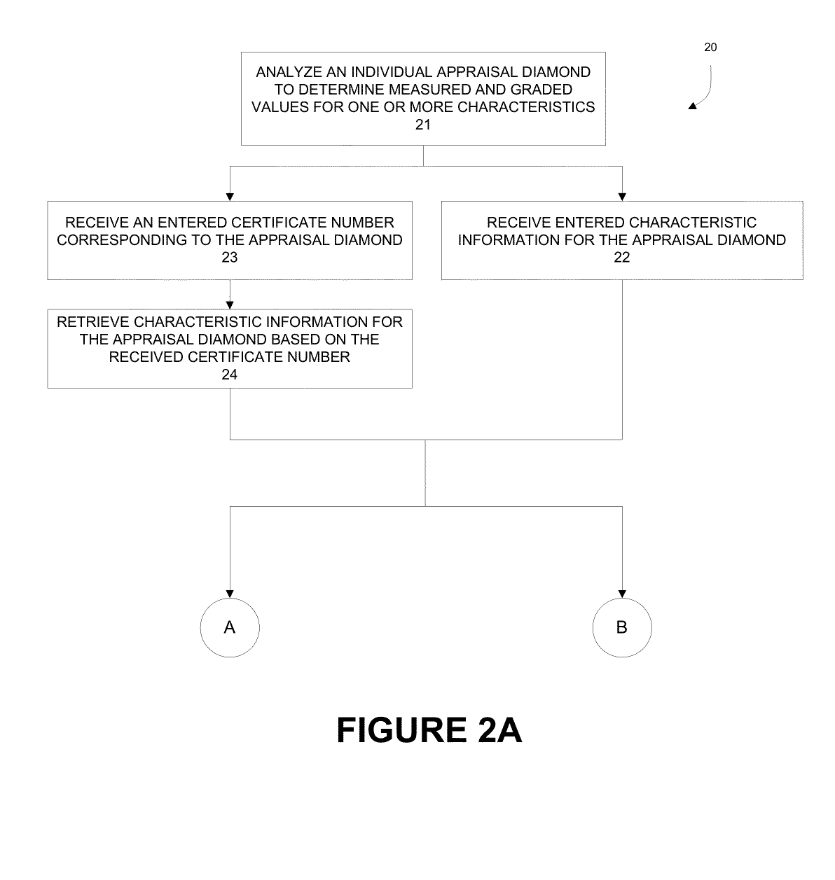

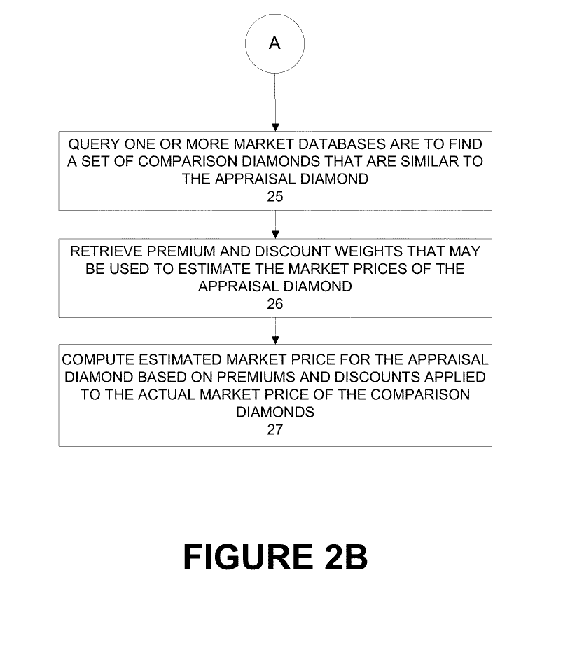

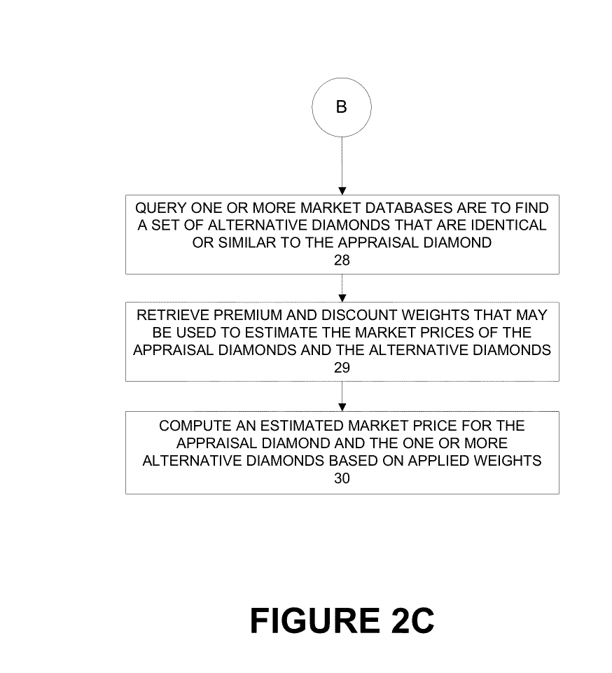

FIG. 2A shows a method 20 for appraising/estimating the price of an individual diamond according to one embodiment. The method 20 may be implemented by one or more components of the diamond appraisal system 1 in conjunction with the one or more external systems 2. For example, the method 20 may be implemented by the diamond comparison unit 6 in conjunction with data received from the one or more external systems 2 through the network controller 7 and inputs received from a user through the user input devices 8. Each element of the method 20 will be described by way of example below.

The method 20 begins at operation 21 with an analysis of an individual diamond. The individual diamond may be already owned by a consumer, a diamond selected by a consumer in a store (brick-and-mortar or online), a diamond selected by a consumer in a commodities market, or selected in any other forum. In these embodiments, the diamond appraisal system 1 may be a portable phone, a tablet computer, a laptop computer, a desktop computer, or similar device while the diamond comparison unit 6 is an application running of the diamond appraisal system 1. The analysis at operation 21 examines the diamond to produce a series of measured and graded characteristic values defining the shape, quality, and general composition of the appraisal diamond. For example, the analysis may include characterization and certification of the appraisal diamond in terms of one or more of shape, weight, color, clarity, cut, polish, symmetry, depth, table, fluorescence, and measurement ratio. These example characteristics may be measured and graded according to Table 1 below.

TABLE 1

| Characteristic | Possible Characteristic Values |
|---|---|
| Shape | Round (RB) |
| | Pear Shape (PS) |
| | Princess (PR) |
| | Marquise (MQ) |
| | Emerald Cut (EC) |
| | Square Emerald Cut (SEC) |
| | Oval (OV) |
| | Radiant (RAD) |
| | Square Radiant Cut (SRD) |
| | Trillion (TRI) |
| | Heart Shape (HS) |
| | Cushion (CU) |
| Weight (carats) | 0.01-10.00+ |
| Color | Colorless D |
| | Colorless E |
| | Colorless F |
| | Near Colorless G |
| | Near Colorless H |
| | Near Colorless I |
| | Near Colorless J |
| | Faint Yellow K |
| | Faint Yellow L |
| | Faint Yellow M |
| | Very Light Yellow N |
| | Very Light Yellow O |
| | Very Light Yellow P |
| | Very Light Yellow Q |
| | Very Light Yellow R |
| | Light Yellow S |
| | Light Yellow T |
| | Light Yellow U |
| | Light Yellow V |
| | Light Yellow W |
| | Light Yellow X |
| | Light Yellow Y |
| | Light Yellow Z |
| Clarity | Flawless (FL) |
| | Internally Flawless (IF) |
| | Very Very Slightly Included (VVS₁) |
| | Very Very Slightly Included (VVS₂) |
| | Very Slightly Included (VS₁) |
| | Very Slightly Included (VS₂) |
| | Slightly Included (SI₁) |
| | Slightly Included (SI₂) |
| | Included (I₁) |
| | Included (I₂) |
| | Included (I₃) |
| Cut | Excellent (EX) |
| | Very Good (VG) |
| | Good (G) |
| | Fair (F) |
| | Poor (P) |
| Polish | Excellent (EX) |
| | Very Good (VG) |
| | Good (G) |
| | Fair (F) |
| | Poor (P) |
| Symmetry | Excellent (EX) |
| | Very Good (VG) |
| | Good (G) |
| | Fair (F) |
| | Poor (P) |
| Depth (%) | 45.0%-82.9% |
| Table (%) | 50.0%-85.9% |
| Fluorescence | None (N) |
| | Faint (F) |
| | Medium (M) |
| | Strong (S) |
| | Very Strong (VS) |
| Measurement Ratio | 1.00/1.00-1.00/3.00 |
| (Length/Width) | |

The characteristics and values shown above in Table 1 are purely for illustrative purposes. In other embodiments, additional or separates sets of characteristics and values may be used to characterize diamonds.

The analysis at operation 21 may be performed by an automated system and/or a human analyst/gemologist. In one embodiment, a user may utilize the camera 11 to capture a digital image or video of the appraisal diamond. At operation 21, the digital image or video of the diamond may be processed by the diamond appraisal system 1 to determine values for one or more characteristics of the appraisal diamond.

In one embodiment, operation 21 issues a certification identifier/number, which identifies the analysis performed at operation 21 for the individual appraisal diamond. The certification identifier/number may be a string of numbers and/or symbols coded or textually represented on a certificate corresponding to the appraisal diamond or inscribed onto/within the diamond.

In one embodiment, operation 21 may be performed by one or more of the external systems 2. For example, operation 21 may be performed by the Gemological Institute of America (GIA), the International Gemological Institute (IGI), the European Gemological Laboratory (EGL), the American Gemological Society (AGS), the Hoge Raad voor de Diamant (HRD Antwerp), the Canadian Institute of Gemmology (CIG), and/or the Gemmological Association of Great Britain, which may operate one or more of the external systems 2. In one embodiment, one or more captured images or videos of the appraisal diamond may be transmitted to a remote gemologist or certification organization for analysis. Based on the captured images, the gemologist may grade and provide measurements according to one or more of the characteristics described above.

Following characterization of the appraisal diamond at operation 21, the method 20 may selectively move to operation 22 or operation 23. The decision to move to operation 22 or operation 23 is based on received input as described below.

At operation 22, the appraisal diamond's characteristics/specifications that were ascertained at operation 21 are entered into the diamond appraisal system 1. In one embodiment, a user may enter the appraisal diamond's characteristics/specifications through the user input devices 8. For example, a user may enter in each characteristic of the appraisal diamond using a keyboard and/or a mouse. As described above, these characteristics may include one or more of the shape, weight, color, clarity, cut, polish, symmetry, depth, table, fluorescence, and measurement ratio of the appraisal diamond.

As noted above, the method 20 may alternatively move to operation 23. At operation 23, a certification identifier/number is entered into the diamond appraisal system 1. In one embodiment, a user may manually enter the certification identifier/number at operation 23 through the user input devices 8. For example, a user may enter in the certification identifier/number of the appraisal diamond using a keyboard and/or a mouse.

After the performance of operation 23, operation 24 retrieves characteristics of the appraisal diamond based on the certification identifier/number entered at operation 23. In one embodiment, the diamond appraisal system 1 may query one or more of the external systems 2 using the certification identifier/number to retrieve characteristics of the appraisal diamond. For example, at operation 24 the diamond appraisal system 1 may transmit a data request to the external systems 2 through the network controller 7. The data request may include the certification identifier/number for the appraisal diamond. In this embodiment, the external system 2 may be a server operated by the GIA or another gemological certification organization. Based on the request, the diamond appraisal system 1 may receive characteristics of the diamond corresponding to the certification identifier/number through the network controller 7.

In the embodiments described above, the characteristics received/retrieved at operations 22-24 are the characteristics ascertained at operation 21. Operation 21 may be separated from operations 22-24 by any amount of time. For example, operations 22-24 may be performed several months after operation 21 characterizes the appraisal diamond. This allows a diamond to be certified independent of a later market value analysis as will be described in further detail below.

Following the completion of operation 22 or operation 24, the method 20 selectively moves down Path A or Path B. Path A estimates the market price of the appraisal diamond based on similar comparison diamonds retrieved from market databases while Path B presents one or more comparison diamonds that are identical to the appraisal diamond and allows the user/consumer alternatively purchase these comparison diamonds based on estimated market prices.

FIG. 2B shows Path A according to one embodiment. Path A begins at operation 25. At operation 25, one or more market databases are queried to find a set of comparison diamonds that are similar to the appraisal diamond. Similar diamonds may be diamonds that share identical characteristics with the appraisal diamond or diamonds that share the same overall tier with the appraisal diamond.

The market databases representing the comparison diamonds may include data showing historical and current actual sales and/or actual offers to sell individual diamonds. The market data may include (1) characteristics of each individual comparison diamond; (2) the actual per carat sale price and/or actual per carat offer price for each individual comparison diamond; and/or (3) the actual total sale price and/or actual offer price for each individual comparison diamond. As will be described in further detail below, the actual prices for one or more comparison diamonds are used to calculate an estimated market price for the individual appraisal diamond based on assigned premium and discount weights.

In one embodiment, diamond characteristics for both the appraisal diamond and the comparison diamonds described in the market databases may be categorized into multiple levels. Table 2 below shows example levels and their applicable characteristic value ranges for the example set of characteristics shown in Table 1.

TABLE 2

| Characteristic | Levels |
|---|---|
| Shape | Level 1: Round (RB) |
| | Level 2: Pear Shape (PS) |
| | Level 3: Princess (PR) |
| | Level 4: Marquise (MQ) |
| | Level 5: Emerald Cut (EC) |
| | Level 6: Square Emerald Cut (SEC) |
| | Level 7: Oval (OV) |
| | Level 8: Radiant (RAD) |
| | Level 9: Square Radiant Cut (SRD) |
| | Level 10: Trillion (TR) |
| | Level 11: Heart Shape (HS) |
| | Level 12: Cushion (CU) |
| Weight (carats) | Level 1: 10.00+ |
| | Level 2: 9.00-9.99 |
| | Level 3: 8.00-8.99 |
| | Level 4: 7.00-7.99 |
| | Level 5: 6.00-6.99 |
| | Level 6: 5.00-5.99 |
| | Level 7: 4.70-4.99 |
| | Level 8: 4.50-4.69 |
| | Level 9: 4.20-4.49 |
| | Level 10: 4.00-4.19 |
| | Level 11: 3.70-3.99 |
| | Level 12: 3.50-3.69 |
| | Level 13: 3.20-3.49 |
| | Level 14: 3.00-3.19 |
| | Level 15: 2.70-2.99 |
| | Level 16: 2.50-2.69 |
| | Level 17: 2.20-2.49 |
| | Level 18: 2.00-2.19 |
| | Level 19: 1.80-1.99 |
| | Level 20: 1.70-1.79 |
| | Level 21: 1.50-1.69 |
| | Level 22: 1.40-1.49 |
| | Level 23: 1.30-1.39 |
| | Level 24: 1.20-1.29 |
| | Level 25: 1.00-1.19 |
| | Level 26: 0.90-0.99 |
| | Level 27: 0.80-0.89 |
| | Level 28: 0.70-0.79 |
| | Level 29: 0.60-0.69 |
| | Level 30: 0.50-0.59 |
| | Level 31: 0.45-0.49 |
| | Level 32: 0.40-0.44 |
| | Level 33: 0.36-0.39 |
| | Level 34: 0.30-0.35 |
| Color | Level 1: Colorless D |
| | Level 2: Colorless E |
| | Level 3: Colorless F |
| | Level 4: Near Colorless G |
| | Level 5: Near Colorless H |
| | Level 6: Near Colorless I |
| | Level 7: Near Colorless J |
| | Level 8: Faint Yellow K |
| | Level 9: Faint Yellow L |
| | Level 10: Faint Yellow M |
| | Level 11: Very Light Yellow N |
| | Level 12: Very Light Yellow O |
| | Level 13: Very Light Yellow P |
| | Level 14: Very Light Yellow Q |
| | Level 15: Very Light Yellow R |
| | Level 16: Light Yellow S |
| | Level 17: Light Yellow T |
| | Level 18: Light Yellow U |
| | Level 19: Light Yellow V |
| | Level 20: Light Yellow W |
| | Level 21: Light Yellow X |
| | Level 22: Light Yellow Y |
| | Level 23: Light Yellow Z |
| Clarity | Level 1: Flawless (FL) |
| | Level 1: Internally Flawless (IF) |
| | Level 2: Very Very Slightly Included (VVS₁) |
| | Level 3: Very Very Slightly Included (VVS₂) |
| | Level 4: Very Slightly Included (VS₁) |
| | Level 5: Very Slightly Included (VS₂) |
| | Level 6: Slightly Included (SI₁) |
| | Level 7: Slightly Included (SI₂) |
| | Level 8: Included (I₁) |
| | Level 9: Included (I₂) |
| | Level 10: Included (I₃) |
| Cut | Level 1: Excellent (EX) |
| | Level 2: Very Good (VG) |
| | Level 3: Good (G) |
| | Level 4: Fair (F) |
| | Level 5: Poor (P) |
| Polish | Level 1: Excellent (EX) |
| | Level 2: Very Good (VG) |
| | Level 3: Good (G) |
| | Level 4: Fair (F) |
| | Level 5: Poor (P) |
| Symmetry | Level 1: Excellent (EX) |
| | Level 2: Very Good (VG) |
| | Level 3: Good (G) |
| | Level 4: Fair (F) |
| | Level 5: Poor (P) |
| Depth (%) | Level 1: 60.0-61.9 |
| | Level 2: 59.0-59.9 or 62.0-62.9 |
| | Level 3: 57-58.9 or 63.0-64.9 |
| | Level 4: 55-56.9 or 65.0-66.9 |
| | Level 5: 50.0-54.9 or 67-69.9 |
| | Level 6: 45.0-49.9 or 70.0-71.9 |
| | Level 7: 72.0-73.9 |
| | Level 8: 74.0-75.9 |
| | Level 9: 76.0-77.9 |
| | Level 10: 78.0-79.9 |
| | Level 11: 80.0-82.9 |
| Table (%) | Level 1: 56.0-57.9 |
| | Level 2: 54.0-55.9 or 58.0-60.9 |
| | Level 3: 50.0-53.9 or 61.0-63.9 |
| | Level 4: 64.0-65.9 |
| | Level 5: 66.0-69.9 |
| | Level 6: 70.0-72.9 |
| | Level 7: 73.0-75.9 |
| | Level 8: 76.0-79.9 |
| | Level 9: 80.0-85.9 |
| Fluorescence | Level 1: None (N) |
| | Level 1: Faint (F) |
| | Level 2: Medium (M) |
| | Level 3: Strong (S) |
| | Level 4: Very Strong (VS) |
| Measurement Ratio | Level 1: 0.60-0.80 |
| (Length/Width) | Level 2: 0.33-0.49 and 0.81-0.90 |
| | Level 3: 0.50-0.59 and 0.91-1.00 |

Based on the levels provided in Table 2, an example appraisal diamond with an RB shape, a 1.10 carat weight, a color grade of F, a clarity grade of VVS₁, a cut grade of EX, a polish grade of EX, a symmetry grade of EX, a depth of 61.0%, a table of 57.8% (presented in round percentage), a fluorescence grade of none, and a measurement ratio of 0.62 would have a level 1 shape, a level 25 weight, a level 3 color, a level 3 clarity, a level 1 cut, a level 1 polish, a level 1 symmetry, a level 1 depth, a level 1 table, a level 1 fluorescence, and a level 1 measurement ratio. One or more of these individual characteristic levels may form an overall tier for the appraisal diamond that represents a combination of one or more characteristics.

In one embodiment, the comparison diamonds retrieved from the market databases may be associated with a characteristic indicating the certification authority or appraisal organization that assigned the actual market prices to the comparison diamonds. Since appraisers and organizations inconsistently assign market prices to diamonds based on varied beliefs regarding the importance/value of characteristics, this characteristic may be used to weight the actual market price of a comparison diamond to account for inconsistencies in valuations.

In one embodiment, operation 25 may select comparison diamonds from the market databases based on tier similarity with the appraisal diamond. For example, operation 25 may select comparison diamonds with the same overall tier as the appraisal diamond. In the case of the above example appraisal diamond, the selected comparison diamonds would have an overall tier corresponding to a level 1 shape, a level 25 weight, a level 1 cut, a level 1 polish, a level 1 symmetry, a level 1 depth, a level 1 table, a level 1 fluorescence, and a level 1 measurement ratio. In this example, both color and clarity between the appraisal diamond and the comparison diamonds may be variable and at different levels. However, these comparison diamonds remain in the same overall tier despite the potential color and clarity differences. To compute the market price of an appraisal diamond based on comparison diamonds, one or more premiums and discounts corresponding to the overall tier of the appraisal diamond and the comparison diamond may be utilized as will be described in further detail below.

In one embodiment, operation 25 seeks to select at least a specified number of comparison diamonds from current market databases that match the overall tier of the appraisal diamond. This specified number reflects a lower bound of comparison diamonds that must be retrieved such that an accurate market estimate for the appraisal diamond may be determined. For example, the lower bound may be set equal to five diamonds. Upon a failure to identify a sufficient number of comparison diamonds from the current market databases to perform an accurate analysis, operation 25 may select comparison diamonds on sale or sold in recent history (e.g., one year ago). In this embodiment, corresponding historical premium and discount weights for these comparison diamonds are used to calculate the estimated market price of the appraisal diamond based on current other market evaluations.

Upon selecting one or more comparison diamonds, operation 26 retrieves premium and discount weights that may be used to estimate the market prices of the appraisal diamond. Each of the premiums and discounts correspond to the shared tier of the appraisal and comparison diamonds. The premium and discount weights may be stored locally in the memory unit 5 of the diamond appraisal system 1 (e.g., the weights 9) or may be retrieved from the external systems 2 using the network controller 7.

Table 3 below shows an example set of premium and discount weights that may be used to estimate the market price of the appraisal diamond based on the actual market price of a comparison diamond.

TABLE 3

| | | Clarity | | | | | | |
|---|---|---|---|---|---|---|---|---|
| | | IF | VVS1 | VVS2 | VS1 | VS2 | SI1 | SI2 |
| Color | D | 0% | −28% | −37% | −47% | −55% | −68% | −73% |
| | E | −31% | −37% | −49% | −55% | −61% | −70% | −75% |
| | F | −43% | −50% | −56% | −58% | −64% | −71% | −76% |
| | G | −54% | −56% | −60% | −65% | −69% | −75% | −79% |
| | H | −62% | −63% | −67% | −70% | −72% | −75% | −79% |
| | I | −69% | −70% | −73% | −74% | −76% | −77% | −80% |
| | J | −75% | −76% | −77% | −78% | −79% | −81% | −82% |
| | K | −79% | −79% | −79% | −81% | −82% | −84% | −86% |
| | L | −83% | −83% | −84% | −84% | −86% | −87% | −88% |
| | M | −85% | −85% | −85% | −88% | −88% | −89% | −89% |

Table 3 represents weights for an overall tier defined by a level 1 shape, a level 25 weight, a level 1 cut, a level 1 polish, a level 1 symmetry, a level 1 depth, a level 1 table, and a level 1 fluorescence. The percentage values define the premium and discount weights that may be applied between diamonds in this tier based on differences in color and clarity.

Table 4 shows another example set of premiums and discount weights that may be used to estimate the market price of the appraisal diamond based on the actual market price of a comparison diamond.

TABLE 4

| | | Clarity | | | | | | |
|---|---|---|---|---|---|---|---|---|
| | | IF | VVS1 | VVS2 | VS1 | VS2 | SI1 | SI2 |
| Color | D | −23% | −46% | −47% | −56% | −62% | −70% | 75% |
| | E | −40% | −48% | −53% | −62% | −67% | −74% | −77% |
| | F | −45% | −49% | −59% | −63% | 68% | −75% | −78% |
| | G | −55% | −64% | −65% | −67% | −68% | −76% | −80% |
| | H | −66% | −67% | −70% | −71% | −72% | −76% | −81% |
| | I | −70% | −72% | −73% | −78% | −79% | −80% | −82% |
| | J | −74% | −75% | −76% | −79% | −80% | −82% | −83% |
| | K | −76% | −77% | −80% | −81% | −82% | −84% | −85% |
| | L | −85% | −85% | −85% | −86% | −86% | −87% | −88% |
| | M | −86% | −86% | −86% | −87% | −87% | −87% | −88% |

The tier represented by Table 4 is defined by a level 1 shape, a level 25 weight, a level 1 cut, a level 1 polish, a level 1 symmetry, a level 1 depth, a level 1 table, and a level 2 fluorescence. In this example, Table 4 differs from Table 3 by only a level of fluorescence (i.e., level 2 v. level 1). Multiple sets of premium and discount weights (e.g., multiple tables) may be used to calculate the estimated market price for the appraisal diamond based on one or more comparison diamonds. As can been seen in Tables 3 and 4, one character change causes a different change in premium/discount weights for every different quality.

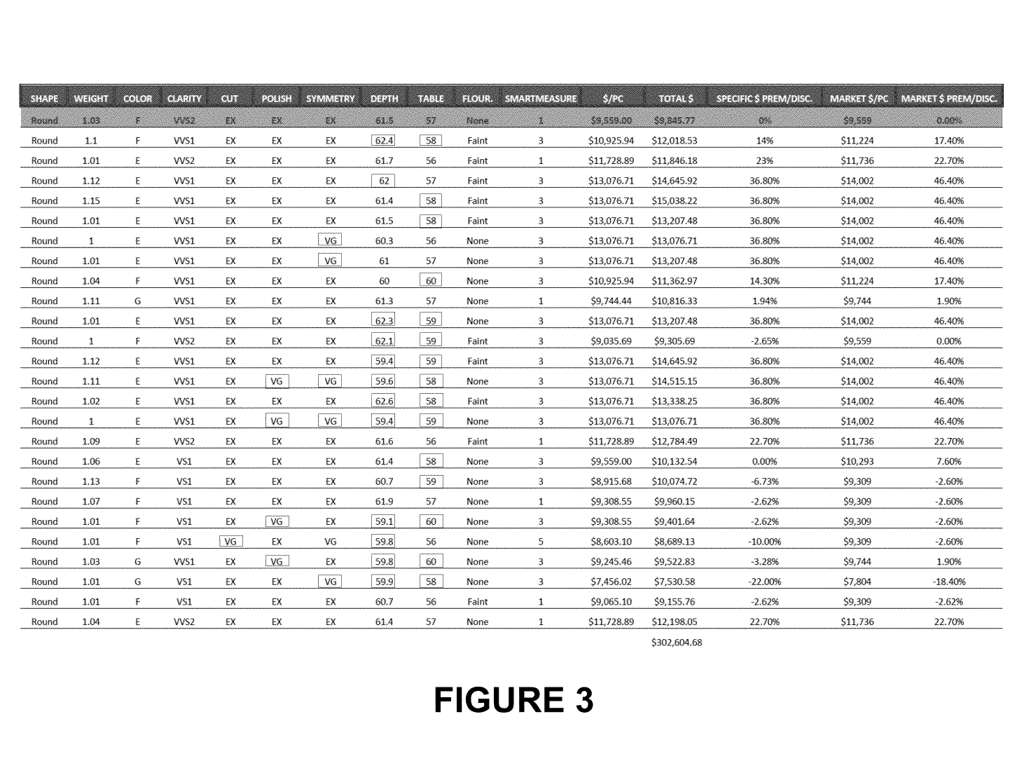

Upon selecting one or more comparison diamonds and retrieving one or more sets of premium and discount weights, operation 27 computes an estimated market price for one or more appraisal diamonds. FIG. 3 shows estimated market prices for twenty-five appraisal diamonds based on a single comparison diamond (represented by the topmost row). As shown, each characteristic that causes a discount to be applied to generate the estimated market price of an appraisal diamond is inscribed in a box. The price per carat ($/PC) represents the calculated price taking all characteristics into account, the total price (TOTAL $) is the price per carat multiplied by the carat weight, the specification price premium/discount (SPECIFIC $ PREM/DISC.) represents the specific percentage premiums/discounts based on all characteristics, the market price per carat (MARKET $/PC) represents the calculated price based on premiums/discounts of color and clarity only different from the comparison/reference diamond, which is level 1 in all other characteristics, and the market price premium/discount (MARKET $ PREM/DISC.) represents the percentage premiums/discounts based on color and clarity difference from the comparison/reference diamond, which is level 1 in all other characteristics.

As described above, the estimated market price of the appraisal diamond is computed relative to the actual market price for one or more comparison diamonds retrieved from market databases. This estimated market price may be presented to a user as shown in FIG. 3. By computing the estimated market price of the appraisal diamond relative to the actual market prices of other diamonds, the method 20 determines the monetary value of the appraisal diamond relative to changing market conditions. This estimated market value may thereafter be utilized by a consumer/user to determine a bid price for the appraisal diamond or whether a proposed purchase price for the appraisal diamond is a fair offer in light of market conditions. Upon the estimation of the market price of the appraisal diamond, Part A of method 20 may terminate.

Turning now to FIG. 2C, Path B may begin at operation 28. At operation 28, alternative diamonds are selected from the market databases. The alternative diamonds are identical or similar to the appraisal diamond. For example, the alternative diamonds may share the same overall tier with the appraisal diamond. In one embodiment, the alternative diamonds are selected in a similar fashion as described above in relation to selection of comparison diamonds at operation 25.

Upon selecting one or more alternative diamonds, operation 29 retrieves premium and discount weights that may be used to estimate the market prices of the appraisal diamonds and the alternative diamonds. Each of the premiums and discounts correspond to the tier of the appraisal diamond and the alternative diamonds. The premium and discount weights may be stored locally in the memory unit 5 of the diamond appraisal system 1 (e.g., the weights 9) or may be retrieved from the external systems 2 using the network controller 7. Tables 3 and 4 are example sets of premium and discount weights that may be used to estimate the market prices for the appraisal diamond and the alternative diamonds.

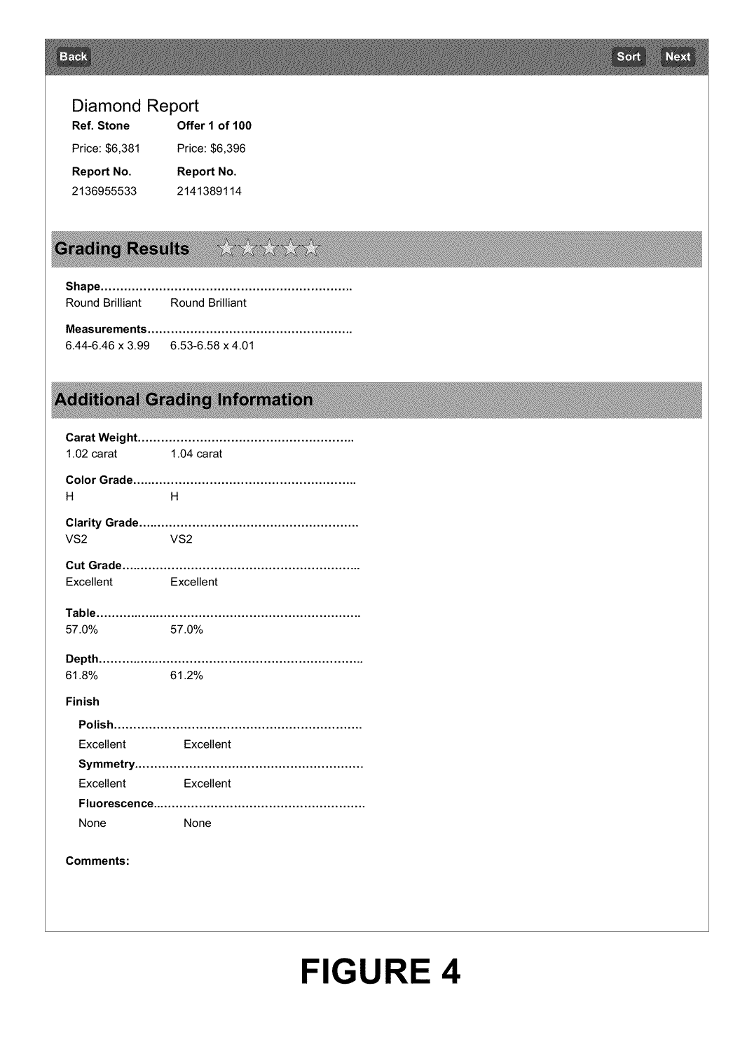

Upon selecting one or more alternative diamonds and retrieving one or more sets of premium and discount weights, operation 30 computes an estimated market price for the appraisal diamond and the one or more alternative diamonds. The estimated market price for the appraisal diamond and the alternative diamonds may be computed in a similar fashion as described above in relation to operation 27. FIG. 4 shows a user interface, which presents the characteristics and estimated market price of the appraisal diamond and the characteristics and estimated market prices of one-hundred alternative diamonds. The user may scroll through the interface to examine each alternative diamond. The market price of the appraisal diamond shown in FIG. 4 may be calculated based on the weights in Table 3 to arrive at the market prices shown in Table 5 below.

TABLE 5

| | | Clarity | | | | |
|---|---|---|---|---|---|---|
| | | IF | VVS1 | VVS2 | VS1 | VS2 |
| Color | D | $22,789 | $16,597 | $14,183 | $11,890 | $9,948 |
| | E | $15,352 | $13,944 | $11,490 | $10,156 | $8,634 |
| | F | $12,652 | $11,164 | $9,763 | $9,342 | $8,103 |
| | G | $10,322 | $9,726 | $8,891 | $7,774 | $7,422 |
| | H | $8,965 | $8,344 | $7,487 | $6,897 | $6,381 |
| | I | $7,033 | $6,846 | $6,142 | $5,765 | $5,442 |

By estimating the prices of alternative diamonds in a similar fashion as is used to estimate the market price for the appraisal diamond, the method 20 and the diamond appraisal system 1 described above provides a powerful analytical tool that allows consumers to determine fair prices for diamonds. This increased knowledge and visibility into market prices of diamonds in turn increases consumer confidence and facilitates diamond purchases for both novice and expert consumers.

As explained above, an embodiment may be a machine-readable medium (such as microelectronic memory) having stored thereon instructions, which program one or more data processing components (generically referred to here as a “processor”) to perform the operations described above. In other embodiments, some of these operations might be performed by specific hardware components that contain hardwired logic (e.g., dedicated state machines). Those operations might alternatively be performed by any combination of programmed data processing components and fixed hardwired circuit components.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. The description is thus to be regarded as illustrative instead of limiting.

What is claimed is:

1. A method for determining an estimated market price for an individual diamond, comprising:
receiving characteristics of the individual diamond;
selecting one or more comparison diamonds from a market database;
assigning, by a computer, weights to actual market prices of the comparison diamonds; and
computing, by the computer, the estimated market price for the individual diamond based on the weights and the actual market prices for each of the comparison diamonds.

2. The method of claim 1, wherein receiving characteristics of the individual diamonds comprises:
receiving a certification number corresponding to the individual diamond; and
retrieving the characteristics of the individual diamond based on the certification number.

3. The method of claim 1, wherein the comparison diamonds are selected based on similarities between the characteristics of the individual diamond and characteristics of the comparison diamonds.

4. The method of claim 3, wherein each of the characteristics of the individual diamond and the comparison diamonds are assigned hierarchical levels such that each level for each characteristic represents a range of values.

5. The method of claim 4, wherein one or more characteristic levels define an overall tier level.

6. The method of claim 5, wherein selected comparison diamonds share the same tier level with the individual diamond.

7. The method of claim 6, further comprising:
retrieving a set of weights corresponding to the tier level shared by the comparison diamonds and the individual diamond.

8. The method of claim 7, wherein assigning weights to the comparison diamonds based on the determined differences comprises:
assigning a premium weight to each characteristic of a comparison diamond that is at a lower level than a corresponding characteristic of the individual diamond, wherein the premium weights indicate an increase in an estimated market price of the individual diamond relative to the actual market price of the corresponding comparison diamond; and
assigning a discount weight to each characteristic of a comparison diamond that is at a higher level than a corresponding characteristic of the individual diamond, wherein the discount weights indicate a decrease in the estimated market price of the individual diamond relative to the actual market price of the corresponding comparison diamond.

9. The method of claim 8, further comprising:
presenting the estimated market price of the individual diamond through a user interface.

10. The method of claim 9, further comprising:
computing, by the computer, an estimated market price for each of the comparison diamonds based on the weights; and
presenting the estimated market price of the comparison diamonds through the user interface.

11. The method of claim 1, wherein the actual market prices of the comparison diamonds reflect proposed sale prices or actual sales prices for the comparison diamonds.

12. The method of claim 1, wherein the characteristics include one or more of shape, weight, color, clarity, cut, polish, symmetry, depth, table, fluorescence, and measurement ratio of the individual diamond.

13. An article of manufacture, comprising:
a non-transitory machine-readable storage medium that stores instructions which, when executed by a processor in a computer,
process characteristics of the individual diamond;
select one or more comparison diamonds from a market database;
assign weights to actual market prices of the comparison diamonds; and
compute the estimated market price for the individual diamond based on the weights and the actual market prices for each of the comparison diamonds.

14. The article of manufacture of claim 13, wherein the comparison diamonds are selected based on similarities between the characteristics of the individual diamond and characteristics of the comparison diamonds.

15. The article of manufacture of claim 14, wherein each of the characteristics of the individual diamond and the comparison diamonds are assigned hierarchical levels such that each level for each characteristic represents a range of values.

16. The article of manufacture of claim 15, wherein one or more characteristic levels define an overall tier level and selected comparison diamonds share the same tier level with the individual diamond.

17. The article of manufacture of claim 16, wherein the non-transitory machine-readable storage medium stores further instructions, which when executed by the processor in the computer,
retrieve a set of weights corresponding to the tier level shared by the comparison diamonds and the individual diamond;
assign a premium weight to each characteristic of a comparison diamond that is at a lower level than a corresponding characteristic of the individual diamond, wherein the premium weights indicate an increase in an estimated market price of the individual diamond relative to the actual market price of the corresponding comparison diamond; and
assign a discount weight to each characteristic of a comparison diamond that is at a higher level than a corresponding characteristic of the individual diamond, wherein the discount weights indicate a decrease in the estimated market price of the individual diamond relative to the actual market price of the corresponding comparison diamond.

18. The article of manufacture of claim 17, wherein the non-transitory machine-readable storage medium stores further instructions, which when executed by the processor in the computer,
present the estimated market price of the individual diamond through a user interface.

19. A diamond appraisal computer system for determining an estimated market price for an individual diamond, comprising:
a hardware processor to:
select one or more comparison diamonds from a market database;
assign weights to actual market prices of the comparison diamonds; and
compute the estimated market price for the individual diamond based on the weights and the actual market prices for each of the comparison diamonds.

20. The diamond appraisal computer system of claim 19, wherein the comparison diamonds are selected based on similarities between the characteristics of the individual diamond and characteristics of the comparison diamonds.

21. The diamond appraisal computer system of claim 20, wherein each of the characteristics of the individual diamond and the comparison diamonds are assigned hierarchical levels such that each level for each characteristic represents a range of values.

22. The diamond appraisal computer system of claim 21, wherein one or more characteristic levels define an overall tier level.

23. The diamond appraisal computer system of claim 22, wherein selected comparison diamonds share the same tier level with the individual diamond.

24. The diamond appraisal computer system of claim 23, wherein the hardware processor computes the estimated market price for the individual diamond by:
assigning a premium weight to each characteristic of a comparison diamond that is at a lower tier than a corresponding characteristic of the individual diamond, wherein the premium weights indicate an increase in an estimated market price of the individual diamond relative to an actual market price of the corresponding comparison diamond; and
assigning a discount weight to each characteristic of a comparison diamond that is at a higher tier than a corresponding characteristic of the individual diamond, wherein the discount weights indicate a decrease in the estimated market price of the individual diamond relative to the actual market price of the corresponding comparison diamond.
